(19) United States
(12) Patent Application Publication
(10) Pub. No.: US 2023/0271604 A1
(43) Pub. Date: Aug. 31, 2023

(54) AUTOMATIC DRIVER ASSIST SYSTEM FOR A VEHICLE

(71) Applicant: NISSAN NORTH AMERICA, INC., Franklin, TN (US)

(72) Inventors: Erik St. Gray, San Jose, CA (US); Erik Vinkhuyzen, Morgan Hill, CA (US)

(21) Appl. No.: 17/682,698

(22) Filed: Feb. 28, 2022

(51) Int. Cl. B60W 30/09; B60W 50/14

(52) U.S. Cl. CPC B60W 30/09; B60W 50/14; B60W 2050/143; B60W 2050/146; B60W 2540/229

(57) ABSTRACT

An automatic driver assist system for a vehicle comprising a first sensor, a second sensor, and a controller. The first sensor is configured to detect driver data relating to a current state of a driver of the vehicle. The second sensor is configured to detect external environment data relating to an external environment of the vehicle. The controller is configured to activate one of a plurality of vehicle drive assist system components based on the driver data and on the external environment data.

### BACKGROUND

### Technical Field

The present disclosure generally relates to an automatic driver assist system and a method of activating an automatic driver assist system. More specifically, the present disclosure relates to a system and method of activating one of a plurality of vehicle drive assist system components based on detected driver data and detected external environment data.

### Background Information

Driver assist systems are currently used in vehicles to increase car and road safety. One conventional driver assist system is a forward collision warning system that provides an alert regarding a hazard in front of the vehicle to provide a driver with an opportunity to brake or swerve to avoid the obstacle. Another conventional driver assist system provides driver assistance based on 360 degree monitoring of the vehicle, such as a lane departure warning and a blind sport warning.

These conventional driver assist systems are turned on and off at the discretion of the driver. Two types of conventional driver assist systems are used in vehicles. A first conventional driver assist system is an active safety system. The other type of conventional driver assist system is an automated driving system.

The active safety system is engaged by the driver and remains active in the background until disengaged by the driver. When the active safety system is turned on by the driver, the active safety system intervenes at the last moment to assist the driver in avoiding a collision. The active safety system can provide a warning regarding the possibility of a collision. Because the active safety system is configured to operate at the last moment, the active safety system can be dangerous for other vehicles in the vicinity of the vehicle that have to respond to a last minute action of the vehicle, such as a rapid deceleration. Further, by acting at the last minute, the driver can experience discomfort and stress associated with attempting to avoid a collision.

The automated driving system adds the ability to manage steering, braking and propulsion systems of the vehicle to assist in avoiding a collision. The automated driving system can also be dangerous to other vehicles in the vicinity when managing a vehicle to avoid a collision, as well as causing discomfort and stress to the driver. The conventional automated driving system is also engaged at the discretion of the driver.

As an example, a driver is driving a first vehicle on a dry, divided highway with traffic signals during daylight hours. There is no adverse weather and moderate traffic. A second vehicle is directly ahead of the first vehicle in the leftmost through lane of a road with five lanes. Both the first and second vehicles come to a stop in queue at a stoplight. The gaze of the driver of the first vehicle is averted to adjust the radio and to reach for an object in the area of the adjacent passenger seat. During this distraction, the driver of the first vehicle eases off the brake and rolls forward, and hits a rear end of the second vehicle.

In another example, a driver of a first vehicle is stopped at a traffic light in a dedicated right turn lane. A second vehicle is in the right turn lane between the traffic light and the first vehicle. The second vehicle moves forward, and prepares to make a right turn on a red light. The second vehicle stops partway into the intersection to wait for traffic to clear. The driver of the first vehicle follows behind the second vehicle, and the gaze of the driver is averted to the left to check for traffic conditions. The driver of the first vehicle accelerates into the intersection without checking whether the second vehicle has completed the right turn. The first vehicle hits a read end of the second vehicle.

In another example, a driver of a first vehicle is driving on a dry, undivided roadway at night in the only through lane in the direction of travel. The road is well-lit and there is almost no traffic. The driver of the first vehicle approaches a stoplight and stops behind a second vehicle, which is stopped at the stop light. While stopped, the driver of the first vehicle reaches for an object in the area of the adjacent passenger seat. The driver of the first vehicle inadvertently moves forward slowly and the attention of the driver is diverted to the object in hand from the adjacent passenger area. The second vehicle moves forward slightly and stops. The driver of the first vehicle is looking down when the first vehicle hits a rear end of the second vehicle.

In each of the preceding examples, the driver was distracted. The distraction is not limited to the driver adjusting the radio or looking at a phone. The driver can be focused on other aspects of the driving scene, such as checking for traffic when making a turn at an intersection. The attention of the driver is diverted elsewhere, although the driver is safely operating the vehicle, such that an accident occurs from an unintended driving operation.

The conventional driver assist systems require activation by the driver. In each of the preceding examples, when the conventional driver assist system is not activated by the driver, the conventional driver assist system provides no assistance in avoiding the rear end collision.

### SUMMARY

The automatic driver assist system of the present disclosure activates a component of the automatic driver assist system when a driver is detected to not be paying attention to a roadway, thereby facilitating avoiding a rear-end collision with another vehicle. The automatic driver assist system of the present disclosure preferably engages when the driver is detected to not be looking ahead out of a front window of the vehicle. In an exemplary embodiment, the automatic driver assist system engages a car following behavior in which a current speed of the vehicle is maintained, and the vehicle no longer accepts acceleration input from the driver. This state persists until the driver focuses out of the front window again. The automatic driver assist system of the present disclosure does not require activation by the driver.

In view of the state of the known technology, one aspect of the resent disclosure is to provide an automatic driver assist system for a vehicle including a first sensor, a second sensor, and a controller. The first sensor is configured to detect driver data relating to a current state of a driver of the vehicle. The second sensor is configured to detect external environment data relating to an external environment of the vehicle. The controller is configured to activate one of a plurality of vehicle drive assist system components based on the driver data and on the external environment data.

Another aspect of the present disclosure is to provide a method of activating an automatic driver assist system of a vehicle. Driver data relating to a current state of a driver of the vehicle is detected with a first sensor. External environment data relating to an external environment of the vehicle is detected with a second sensor. One of a plurality of vehicle drive assist system components is activated based on the detected driver data and the detected external environment data.

Also other objects, features, aspects and advantages of an automatic driver assist system and a method of activating an automatic driver assist system will become apparent to those skilled in the art from the following detailed description, which, taken in conjunction with the annexed drawings, discloses exemplary embodiments of the automatic driver assist system and the method of activating an automatic driver assist system.

### BRIEF DESCRIPTION OF THE DRAWINGS

Referring now to the attached drawings which form a part of this original disclosure:

FIG. 1 is a schematic diagram of an automatic drive assist system for a host vehicle in accordance with an exemplary embodiment;

FIG. 2 is a block diagram of exemplary components of the host vehicle equipped with the automatic drive assist system;

FIG. 3 is a perspective view of an instrument panel in a passenger compartment of the vehicle of FIG. 1;

FIG. 4 is perspective view of a display screen of a user interface of the instrument panel of FIG. 3;

FIG. 5 is a perspective view of another display screen of the user interface of the instrument panel of FIG. 3;

FIG. 6 is a perspective view of another display screen of the user interface of the instrument panel of FIG. 3 providing a notification to a driver;

FIG. 7 is a perspective view of another display screen of the user interface of the instrument panel of FIG. 3 providing a message to a driver;

FIG. 8 is a flowchart illustrating the automatic drive assist system of FIG. 1;

FIG. 9 is a perspective view of a lateral field of vision of a driver; and

FIG. 10 is a perspective view of a vertical field of vision of a driver.

### DETAILED DESCRIPTION OF EXEMPLARY EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

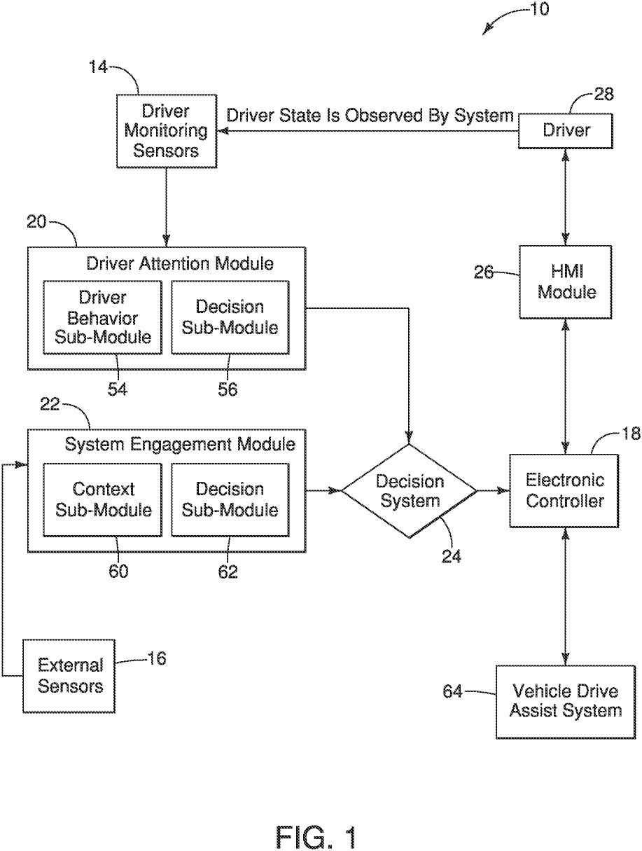

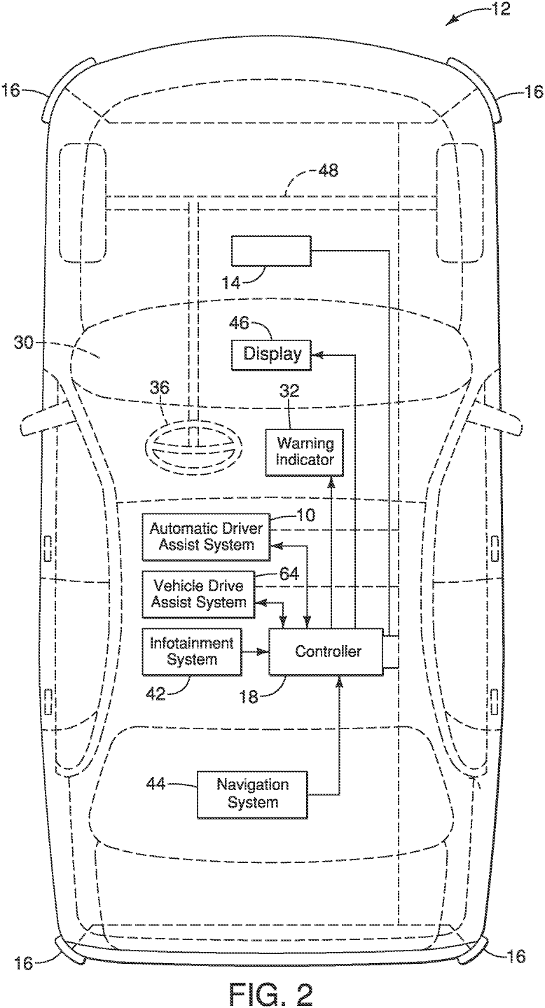

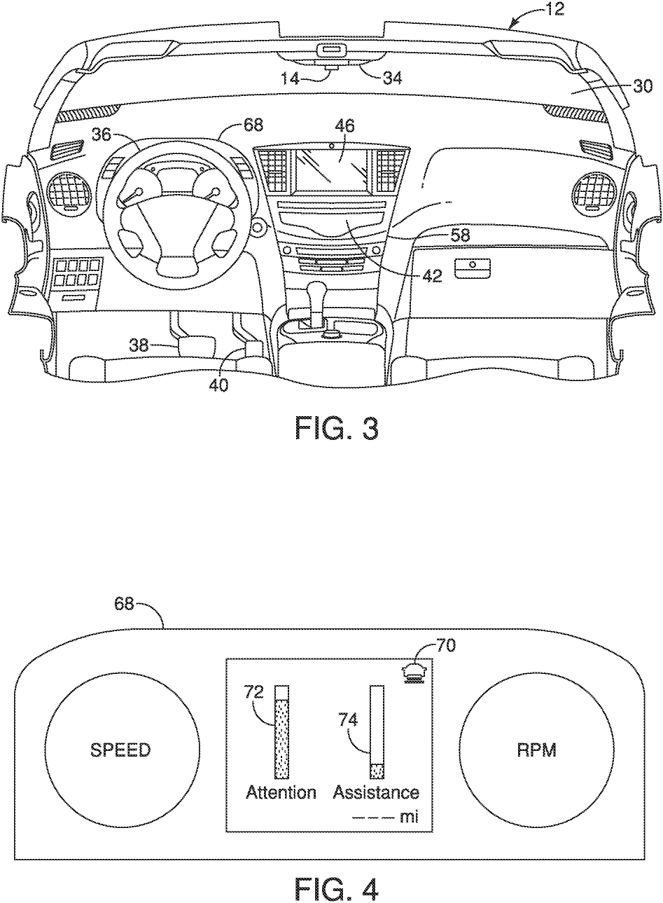

FIG. 1 illustrates an automatic driver assist system 10 in accordance with an exemplary embodiment of the present disclosure. As shown in FIGS. 2 and 3, a host vehicle 12 is equipped with the automatic driver assist system 10.

The automatic driver assist system 10, as shown in FIG. 1, includes a first sensor 14, a second sensor 16, and an electronic controller 18. The automatic driver assist system 10 further includes a driver attention module 20, a system engagement module 22, a decision module 24, and a human-machine interface (HMI) module 26.

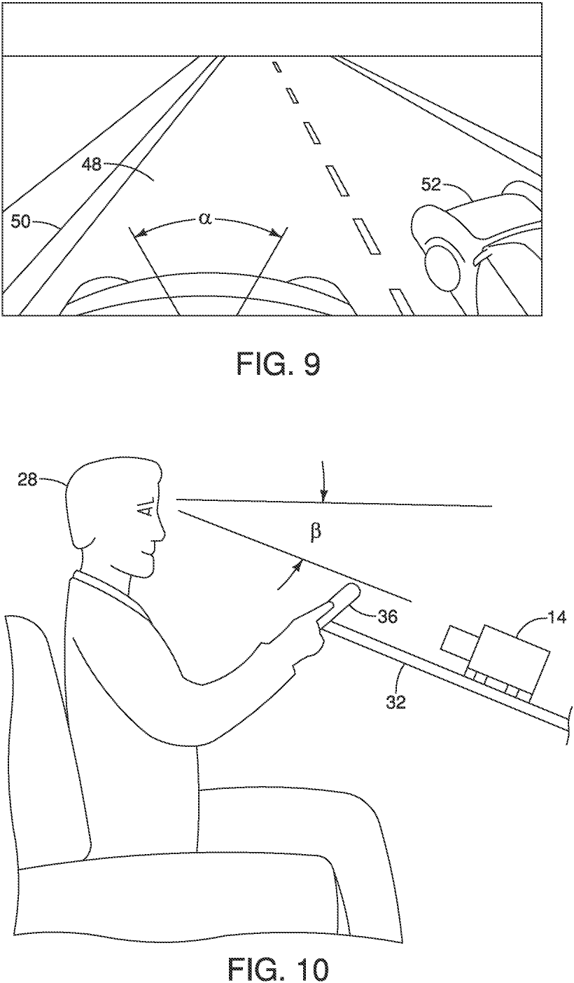

The first sensor 14 is configured to detect driver data relating to a current state of a driver 28 of the vehicle 12. The driver data includes an attention level of the driver 28. The first sensor 14 is preferably configured to track head pose and driver gaze of the driver 28. In other words, the first sensor 14 is a driver monitoring sensor. The head pose is a vertical orientation, or up and down movement, of a head of the driver 28, as shown in FIG. 10. The driver gaze is a horizontal orientation, or left and right movement, of the head of the driver 28, as shown in FIG. 9. The first sensor 14 can be any suitable sensor, such as an infrared camera, that is configured to track head and eye movement of the driver 28. The first sensor 14 can be mounted in any suitable location in a vehicle cabin 30, or interior, of the vehicle, such as on the steering column 32 (FIG. 10) or the rear-view mirror 34 (FIG. 2).

Additionally, the first sensor 14 can include a plurality of first sensors. The first sensor 14 is configured to detect interactions of the driver 28 with a vehicle control component, such as a steering wheel 36, a brake pedal 38, or an acceleration pedal 40. The first sensor 14 is configured to detect a driver’s state based on the interaction of the driver 28 with the vehicle control component, such as whether the driver is not maintaining a constant position of the accelerator pedal 40.

The first sensor 14 can be a scene camera configured to view activity in the vehicle cabin 30. The first sensor 14 can be mounted near the rear-view mirror 34 or any other suitable location. Alternatively, the first sensor 14 can be a low-power Lidar configured to capture a 3D view of the vehicle cabin 30. Alternatively, the first sensor 14 can be configured to detect noise in the vehicle cabin 30. Alternatively, the first sensor 14 can be configured to detect interactions of the driver 28 with other vehicle components, such as an infotainment system 42 or a navigation system 44. As shown in FIG. 3, the infotainment system 42 and the navigation system 44 can be interacted with through a display 46.

The second sensor 16 is configured to detect external environment data relating to an external environment of the host vehicle 12. As shown in FIG. 2, a plurality of second sensors 16 is disposed externally of the host vehicle 12 in any suitable location to detect the external environment of the host vehicle 12.

The second sensor 16 is configured to detect driving context and driving activity. In other words, the second sensor 16 is configured to detect information regarding the environment external to the host vehicle 12. The second sensor 16 can be any suitable sensor, such as a camera, a Lidar, a radar, and a navigation system map of the navigation system 44. The second sensor 16 is configured to detect the surroundings of the host vehicle 12, such as other vehicles in the vicinity and the position of the host vehicle 12 in a lane 48 (FIG. 9) of a road 50 being traveled. The second sensor 16 is configured to detect the type of road being traveled by the host vehicle 12, such as a highway or a residential street. For example, external environment data detected by the second sensor can include, but is not limited to, whether the host vehicle 12 is staying in the same lane 50, whether the host vehicle 12 is passing another vehicle 52 or performing a vehicle maneuver, whether the host vehicle 12 is performing low-speed city driving, whether the host vehicle 12 is performing a turn at a traffic-controlled intersection (e.g., an intersection with a traffic light), whether the host vehicle 12 is driving through a self-organized intersection (e.g., a four way stop intersection), whether other vehicles 52 are located in the vicinity of the host vehicle 12 and the position of the other vehicles 52 relative to the host vehicle 12, and whether the host vehicle 12 is driving through a school zone or other area having a temporary reduced speed limit.

Previous designs mean support is either always on or always off, and do nothing for a distracted driver who has not already engaged driving support. They thus rely on last-minute active safety systems to stave off collisions. This approach produces a better user experience by triggering longer-range support when needed, via active monitoring of the driver.

The driver attention module 20 includes a driver behavior sub-module 54 and a decision sub-module 56, as shown in FIG. 1. The driver behavior sub-module 54 is configured to determine a current state of the driver 28. The decision sub-module 56 determines when the determined current state of the driver 28 meets a predetermined threshold.

The diver behavior sub-module 54 receives information from the first sensor 14 relating to the current state of the driver 28 of the vehicle 12, as shown in FIG. 1. The diver behavior sub-module 54 identifies the type of behavior the driver 28 is engaged in based on the information received from the first sensor 14. For example, the diver behavior sub-module 54 can determine where the driver 28 is looking, what controls the driver 28 is inputting to the vehicle 12, and what the driver 28 is touching, holding, and/or interacting-with. The diver behavior sub-module 54 can then identify the impact of that behavior in real-time to an awareness or alertness of the driver (i.e., a current state) to context features.

For example, when the diver behavior sub-module 54 determines that the driver 28 is looking down at a radio of the infotainment system 42, the diver behavior sub-module 54 determines that the current state of the driver 28 has a low impact on an ability of the driver 28 to see a traffic situation ahead of the host vehicle 12. When the diver behavior sub-module 54 determines that the driver 28 is looking at an occupant in a backseat of the host-vehicle, the diver behavior sub-module 54 determines that the current state of the driver 28 has a large impact on the ability of the driver 28 to see the traffic situation ahead of the host vehicle 12.

For example, when the diver behavior sub-module 54 determines that the driver 28 is touching buttons on a center stack 58 of the host vehicle 12, the diver behavior sub-module 54 determines that the current state of the driver 28 has a small impact on the ability of the driver to perform lateral control of the host vehicle 12. The diver behavior sub-module 54 further determines that the determined current state of the driver 28 does not impact the awareness of the driver to traffic ahead of the host vehicle 12 (i.e., longitudinal control). When the diver behavior sub-module 54 determines that the driver 28 is glancing at buttons on the center stack 58 of the host vehicle, the diver behavior sub-module 54 determines that the current state of the driver 28 impacts both lateral and longitudinal control of the host vehicle 12.

The driver attention decision sub-module 56 integrates the impact of the current state of the driver 28 determined by the diver behavior sub-module 54 over-time. The driver attention decision sub-module 56 is configurable to set thresholds for when intervention is warranted based on the current state of the driver 28 for lateral control and longitudinal control of the host vehicle 12.

The driver attention decision sub-module 56 contains a threshold for when driver awareness is sufficiently impacted such that the driver 28 cannot be safe, which sends an override signal to trigger hazard lights and an automatic driver assist system enabled stop of the host vehicle. The host vehicle 12 can be safely brought to a stop when the driver 28 fails to re-engage after a predetermined amount of time. In other words, the first sensor 14 detects that the current state, such as the attention level, of the driver 28 is less than a predetermined threshold for a predetermined amount of time. The current state of the driver 28 is determined by the first sensor 14 on a frame-by-frame analysis, such that the current state of the driver 28 is determined to continue over a predetermined number of frames. The host vehicle 12 is prevented from attempting to operate the vehicle in a fully autonomous mode.

The system engagement module 22 includes a context sub-module 60 and a decision sub-module 62, as shown in FIG. 1. The context sub-module 60 determines a driving context and activity of the host vehicle 12. The decision sub-module 62 determines which component of a vehicle drive assist system 64 can be allowed to operate.

The context sub-module 60 receives external environment data relating to the external environment of the host vehicle 12 from the second sensor 16, as shown in FIGS. 1 and 2. The context sub-module 60 determines the driving context and driving activity based on the external environment data relating to the external environment of the host vehicle received from the second sensor 16. For example, the context sub-module 60 can determine whether the host vehicle 12 is operating in a lane-keeping mode.

The decision sub-module 62 determines which components of the vehicle drive assist system 64 can be allowed to operate based on the driving context and activity determined by the context sub-module 22. The decision sub-module 62 is further configured to set appropriate parameters of the determined component based on the driving context, driving activity, and other detected traffic conditions. The parameters can include, but are not limited to, speed and following distance.

For example, when the context sub-module 60 determines that the host vehicle 12 is operating in a lane-keeping mode on a highway, the decision sub-module 62 determines that lateral control override of the host vehicle 12 can be applied. When the context sub-module 60 determines that the host vehicle 12 is operating in the lane-keeping mode and turning at an intersection, the decision sub-module determines that lateral control override of the host vehicle 12 cannot be applied.

For example, when the context sub-module 60 determines that another vehicle is ahead or oncoming, the decision sub-module 62 determines that longitudinal control of the host vehicle 12 must be applied strictly. When the context sub-module 60 determines that no other vehicles are in the vicinity of the host vehicle 12, the decision sub-module 62 determines that longitudinal control of the host vehicle can be relaxed.

A decision system module 24 receives the outputs from the driver attention module 20 and the system engagement module 22, as shown in FIGS. 1 and 2. The decision system module 24 receives the driver data relating to a current state of the driver detected by the first sensor 14 and the external environment data relating to an external environment of the vehicle detected by the second sensor 16. Based on the received outputs, the decision system module 24 determines whether a component of the vehicle drive assist system 64 should be activated. The decision system module 24 determines whether a component of the vehicle drive assist system 64 is to be operated and/or not be operated based on capabilities of the vehicle drive assist system 64. The capabilities of the vehicle drive assist system vary between vehicles and generations of vehicles such that the decision system module 24 makes such determinations based on the capabilities of the vehicle drive assist system 64 of the host vehicle 12. When a component of the vehicle drive assist system 64 is determined to be activated, the decision system module 24 determines which component of the vehicle drive assist system 64 should be operated. The decision of the decision system module 24 is transmitted to the controller 18, which controls operation of the determined component of the vehicle drive assist system 64.

The driver attention module 20 transmits a signal identifying most relevant component of the vehicle drive assist system 64 for the determined current state of the driver 28. The driver attention module 20 modulates the vehicle drive assist system on and off based on the determined current state of the driver 28. For example, when the driver attention module 20 determines that the driver has re-engaged for a predetermined amount of time following activation of a component of the vehicle drive assist system 64, the drive attention module transmits a signal to disengage the activated component of the vehicle assist drive system 64.

The system engagement module 22 allows and prevents the components of the vehicle drive assist system 64 from operating based on the external environment data determined by the second sensor 16. The system engagement module 22 transmits a configuration for the component of the vehicle drive assist system 64 to be activated, such as a set speed, to the controller 18.

The decision system module 24 transmits a signal to the electronic controller 18 to engage the determined component of the vehicle drive assist system 64 with appropriate parameters, as shown in FIG. 1. The controller associated with the activated component of the vehicle drive assist system 64 provides an appropriate control signal to the electronic controller 18 when configured by the decision system module 24.

The controller 18 is configured to activate one of the components of the vehicle drive assist system 64 based on the driver data detected by the first sensor 14 and the external environment data detected by the second sensor 16, as shown in FIG. 1. The activated component of the vehicle drive assist system 64 is configured to assist lateral control of the vehicle 12, such as a steering assist component. The activated component of the vehicle drive assist system 64 is configured to assist longitudinal control of the vehicle 12, such as a distance control component. The controller 18 is further configured to prevent another one of the components of the vehicle drive assist system 64 from being activated based on the external environment data detected by the second sensor 16. For example, when the second sensor 16 detects the host vehicle 12 is making a turn at an intersection, the controller 18 prevents a component from being activated that affects lateral control of the host vehicle 12, such as a steering assist component.

A real-time HMI module 26 receives a signal from the electronic controller 18, as shown in FIG. 1, to provide information to the driver 28 regarding what control is being provided by the automatic driver assist system 10. An indication can be displayed by an instrument panel 68 disposed in a forward vehicle direction of the steering wheel 36. The indication can be an icon 70 identifying the component activated by the controller 18. The icon 70 indicates the particular component activated by the controller 18.

As shown in FIG. 4, the icon 70 for the distance control component of the drive assist system 64 is not illuminated because the driver attention module 20 has determined the current state of the driver 28 to be attentive. The instrument panel 68 can further display meters 72 and 74 indicating the current state of the driver 28 and a level of assistance required. As shown in FIG. 4, when the current state meter 72 reflects the current state of the driver 28 as being highly attentive, the assistance meter 74 has not risen to a level requiring assistance.

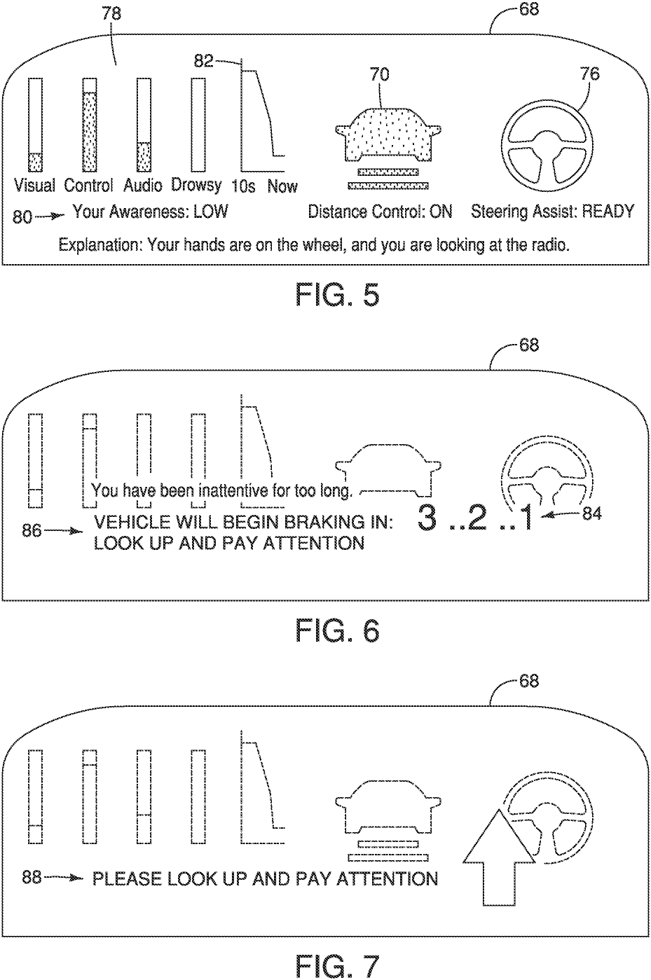

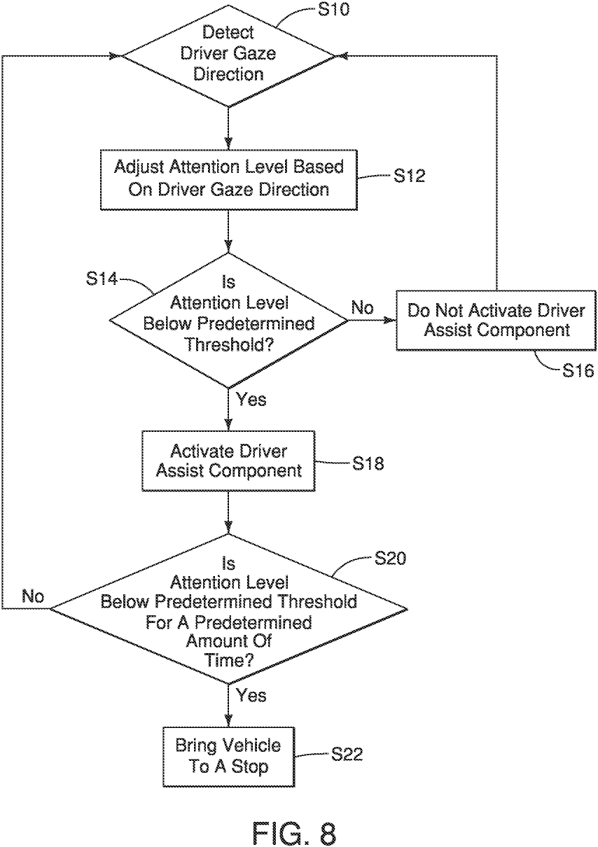

FIG. 5 illustrates another display mode of the instrument panel 68. The icon 70 is illuminated indicating that the controller 18 has activated a distance control component of the vehicle drive assist system 64. The controller 18 is further configured to provide a visual indication when the component of the vehicle drive assist system 64 is activated. The controller 18 can be further configured to provide an audible indication when the component of the vehicle drive assist system 64 is activated. Another icon 76 indicates a steering assist component of the vehicle drive assist system 64. The icon 76 is not illuminated because the steering assist component is not activated by the controller 18.

The instrument panel 68 of FIG. 5 can further include a plurality of meters 78 reflecting various components of the current state of the driver 28. The components of the current state of the driver 28 can include, but are not limited to, a visual component, a control component, an audio component, and/or a drowsy component. The visual component can be based on the head position of the driver 28. The control component can be based on hand and foot position of the driver. The audio component can be based on whether the driver is audibly interacting with another person or thing, such as speaking with a passenger or conducting a telephone call, or a general noise level in the host vehicle 12. The drowsy component can be based on a position of an eyelid of the driver 28. The drowsy component can also be based on any suitable conventional method of detecting whether a driver is drowsy, such as detecting a speed and accuracy of driving corrections performed by the driver through the steering wheel 36. A textual indication 80 can be provided indicating a current state of the driver 28 and an explanation for the determined current state. As shown in FIG. 5, the textual indication 80 provides that the awareness of the driver 28 is low because the hands of the driver are determined to be on the steering wheel 36, but the eyes of the driver are determined to be directed to the radio of the infotainment system 42. The textual indication 80 provides an explanation to the driver 28 regarding detected activity of the driver 28. An audible indication can also be provided to the driver 28. As shown in the meters 78, the control meter is high and the visual meter is low. The audio meter indicates noise in the host vehicle 12 from the radio. The drowsy meter indicates that the driver 28 is not drowsy.

A line graph 80 displayed on the instrument panel 68 reflects the current state of the driver 28 over time. The line graph 80 indicates that the state of the driver 28 ten seconds ago was highly alert, but the current state of the driver 28 is low awareness.

The instrument panel 68 can further include a countdown 84 and a textual warning 86 to inform the driver 28 of when a component of the vehicle drive assist system 64 will be activated and which component, as shown in FIG. 6. The controller 18 is configured to provide the indication when the component of the vehicle drive assist system 64 is activated. The information can also be provided audibly. The current state of the driver 28 is determined to be inattentive for longer than the predetermined amount of time, such that a countdown is initiated indicating braking of the host vehicle 12 will commence shortly to provide longitudinal control of the host vehicle 12. A further indication is provided to the driver 28 to increase the attention of the driver 28, which can also be provided audibly.

As shown in FIG. 7, a further textual indication 88 is provided to the driver 28 during activation of the component of the vehicle drive assist system 10. The indication can be provided to the driver 28 audibly. The indication 88 is a prompt to the driver to resume paying attention to more safely operate the host vehicle 12.

When the driver 28 is determined to have a low attention level for longer than a predetermined amount of time, the controller 18 will bring the host vehicle 12 to a stop to prevent driver abuse of the automatic driver assist system 10 or in the event of the driver 28 is unable to continue safely driving.

The HMI module 26 is configurable such that the driver 28 can customize the components of the vehicle drive assist system 64 that are allowed and prevented from operating. In other words, each of the plurality of components of the vehicle drive assist system 64 is configured to be set on or off through the HMI module 26 to allow or prevent activation by the controller 18. The HMI module 26 can also be configured to customize parameters, such as a following distance for longitudinal control, of each of the components of the vehicle drive assist system 64. The HMI module 26 can also be configured to set the predetermined time at which the current state of the driver is determined to be inattentive resulting in activation of a component of the vehicle drive assist system 64. The HMI module 26 can be configured to be set on or off the automatic driver assist system 10, with the default setting being on for the automatic driver assist system 10.

A flowchart of an exemplary determination of the current state of the driver 28 is shown in FIG. 4. In step S10, the first sensor 14 detects a driver gaze direction. In step S12, the attention level of the driver 28 is adjusted based on the detected driver gaze direction.

In step S14, the attention level is compared to a predetermined threshold. When the attention level is determined to be above the predetermined threshold in step S14, the flowchart proceeds to step S16 in which a component of the vehicle drive assist system 64 is determined to not be activated. The flowchart returns to step S14 and the driver gaze direction is continuously monitored.

When the attention level is determined to be below the predetermined threshold in step S14, the flowchart proceeds to step S18 in which a component of the vehicle drive assist system 64 is determined to be activated.

The flowchart then proceeds to step S20 in which the amount of time of the driver is inattentive is determined. When the amount of time the driver is inattentive is less than a predetermined amount of time, the process returns to step S10 and the driver gaze direction is continuously monitored. The activated component is disengaged when the attention level of the driver is determined to have increased over the predetermined threshold. The controller 18 is configured to deactivate the activated component of the vehicle drive assist system 64 based on the driver data detected by the first sensor 14.

When the amount of time the driver is inattentive is larger than a predetermined amount of time in step S20, the process moves to step S22 in which the vehicle drive assist system 10 brings the host vehicle 12 to a stop. The controller 18 brings the host vehicle 12 to a stop when the first sensor 14 detects the attention level of the driver 28 is less than the predetermined threshold for a predetermined amount of time.

A driver gaze direction is illustrated in FIG. 9. The driver gaze direction is a left-right direction and has a predetermined viewing angle α. When the driver gaze direction is outside the predetermined viewing angle α, the attention of the driver 28 is determined to be directed somewhere other than substantially straight ahead of the host vehicle 12. A driver field of vision is illustrated in FIG. 10. The driver field of vision is an up-down direction and has a predetermined viewing angle β. When the driver gaze direction is outside the predetermined viewing angle β, the attention of the driver 28 is determined to be directed somewhere other than substantially straight ahead of the host vehicle 12.

As an example of determining whether the current state of the driver is inattentive based on the driver gaze direction, the first sensor 14 determines whether the driver gaze direction is outside the predetermined viewing angle α every 0.1 seconds. When the driver gaze direction is outside the predetermined viewing angle α, the visual awareness is decreased by 0.1 times the number of degrees outside of the predetermined viewing angle α. When the driver gaze direction is ten degrees outside the predetermined viewing angle α, the visual awareness level is decreased by 1.0. When the driver gaze direction is within the predetermined viewing angle α, the visual awareness level is increased by 2.0. The visual awareness level can be set such that when the visual awareness level falls below a predetermined level, such as 20.0, the controller 18 activates one of the components of the vehicle drive assist system 64. The controller 18 can also be configured to activate one of the components of the vehicle drive assist system 64 when an average of the visual awareness level for a predetermined amount of time, such as 3.0 seconds, is below a predetermined level, such as 40.0. Similar processes can be performed for other components of the current state of the driver 28 of the host vehicle 12.

The automatic driver assist system 10 of the present disclosure activates a component of the vehicle drive assist system 64 based on driver data detected by the first sensor 14 and external environment data detected by the second sensor 16. The automatic driver assist system 10 of the present disclosure does not rely on activation of the automatic driver assist system 10 by the driver 28 of the host vehicle 12 to be operable.

Each of the modules and sub-modules described herein may be stored in a memory of the host vehicle 12, and executed by a processor. Such modules and sub-modules may be partially or fully included in the electronic controller 18.

The electronic controller 18 preferably includes a microcomputer with a control program that controls the automatic driver assist system ----- as described herein. The controller 18 can also include other conventional components such as an input interface circuit, an output interface circuit, and storage devices such as a ROM (Read Only Memory) device and a RAM (Random Access Memory) device. The microcomputer of the controller 18 is programmed to control the automatic driver assist system 10. The memory circuit stores processing results and control programs, such as ones for operation of the automatic driver assist system 10 that are run by the processor circuit. The internal RAM of the controller 18 stores statuses of operational flags and various control data. The internal ROM of the controller 18 stores the modules and submodules of the automatic driver assist system 10 for various operations. The controller 18 is capable of selectively controlling any of the components of the automatic driver assist system 10 in accordance with the control program.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the automatic driver assist system. Accordingly, these terms, as utilized to describe the present invention should be interpreted relative to a vehicle equipped with the automatic driver assist system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An automatic driver assist system for a vehicle comprising:
a first sensor configured to detect driver data relating to a current state of a driver of the vehicle;
a second sensor configured to capture external environment data relating to an external environment of the vehicle; and
a controller configured to activate one of a plurality of vehicle drive assist system components based on the driver data and on the external environment data.

2. The automatic driver assist system according to claim 1, wherein
the controller is further configured to deactivate the one of the plurality of vehicle drive assist system components based on the driver data.

3. The automatic driver assist system according to claim 1, wherein
the driver data includes an attention level of the driver.

4. The automatic driver assist system according to claim 3, wherein
the controller is further configured to bring the vehicle to a stop when the first sensor detects the attention level of the driver is less than a predetermined threshold for a predetermined amount of time.

5. The automatic driver assist system according to claim 1, wherein
the controller is further configured to prevent another one of the plurality of vehicle drive assist system components from being activated based on the external environment data.

6. The automatic driver assist system according to claim 1, wherein
the controller is further configured to provide a visual indication when the one of the plurality of vehicle drive assist system components is activated.

7. The automatic driver assist system according to claim 1, wherein
the controller is further configured to provide an audible indication when the one of the plurality of vehicle drive assist system components is activated.

8. The automatic driver assist system according to claim 1, wherein
the one of the plurality of vehicle drive assist system components is configured to assist lateral control of the vehicle.

9. The automatic driver assist system according to claim 1, wherein
the one of the plurality of vehicle drive assist system components is configured to assist longitudinal control of the vehicle.

10. The automatic driver assist system according to claim 3, wherein
the attention level of the driver includes at least one of a visual attention level, a control level and a drowsiness level of the driver.

11. The automatic driver assist system according to claim 1, wherein
the automatic driver assist system is configured to be set on or off through a vehicle interface.

12. The automatic driver assist system according to claim 1, wherein
the controller is further configured to provide an indication when the activation of the one of the plurality of vehicle drive assist system components is being activated.

13. The automatic driver assist system according to claim 1, wherein
each of the plurality of vehicle drive assist system components is configured to be set on or off through a vehicle interface to allow or prevent activation by the controller.

14. A method of activating an automatic driver assist system of a vehicle comprising:
detecting driver data relating to a current state of a driver of the vehicle with a first sensor;
detecting external environment data relating to an external environment of the vehicle with a second sensor; and
activating one of a plurality of vehicle drive assist system components based on the detected driver data and the detected external environment data.

15. The method of activating an automatic driver assist system of a vehicle according to claim 14, further comprising
deactivating the one of the plurality of vehicle drive assist system components based on the driver data.

16. The method of activating an automatic driver assist system of a vehicle according to claim 14, further comprising
bringing the vehicle to a stop when the first sensor detects the attention level of the driver is less than a predetermined threshold for a predetermined amount of time.

17. The method of activating an automatic driver assist system of a vehicle according to claim 14, further comprising
preventing another one of the plurality of vehicle drive assist system components from being activated based on the external environment data.

18. The method of activating an automatic driver assist system of a vehicle according to claim 14, further comprising
providing an indication when the one of the plurality of vehicle drive assist system components is activated.

19. The method of activating an automatic driver assist system of a vehicle according to claim 15, further comprising
providing an indication when the activation of the one of the plurality of vehicle drive assist system components is being deactivated.

20. The method of activating an automatic driver assist system of a vehicle according to claim 14, wherein
the detecting driver data includes determining an attention level of a driver of the vehicle.
